(19) United States
(12) Patent Application Publication
(10) Pub. No.: US 2008/0180949 A1
(43) Pub. Date: Jul. 31, 2008

(54) Illumination structure

(75) Inventors: Jui-Tsung Liao, San Chung City (TW); Tai-Ho Huang, San Chung City (TW); Tung-Ching Wu, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 11/727,412

(22) Filed: Mar. 26, 2007

(30) Foreign Application Priority Data
Jan. 30, 2007 (TW) 096201756

(51) Int. Cl. F21V 21/00

(52) U.S. Cl. 362/251; 362/249

(57) ABSTRACT

An illumination structure comprises a FPC (Flexible Printed Circuit) board, several light-emitting diodes and at least one pair of coupling device. The light-emitting diodes are coupled to the FPC board. The at least one pair of coupling device is mounted on respective opposite sides of the FPC board to allow the planar FPC board to be transformed into a three-dimensional shape.

### FIELD OF THE INVENTION

The present invention relates to an illumination structure capable of standing up by itself or winding around other object to be suitable for use in decoration, illumination or the like.

### BACKGROUND OF THE INVENTION

Conventional indoor lamps mostly use halogen bulbs, which generally adopt tungsten filament light sources. The halogen bulbs are relatively cheap in price, but they have drawbacks in practical use such as large heat generation, high power consumption, short lifetime and low reliability.

In order to improve these drawbacks, LED lamp is applied to several kinds of illumination appliances or artistic decorations. However, the LED lamp has a fixed shape. The lamp head of the LED lamp is coupled to the lamp holder or disposed directly on a proper location before insertion of the plug into the power socket to enable the LED lamp to generate illumination. The LED lamp provides the energy-saving effect. But, its shape may be not able to satisfy the user's desire so the user must spend time looking for a desirous lamp, which occupies additional space.

In view of this, the present inventor makes diligent studies in providing general public with a flexible, shape-changeable illumination structure.

### SUMMARY OF THE INVENTION

It is a major object of the present invention to provide an illumination structure that is flexible, shape changeable and does not occupy space.

In order to achieve the foregoing object, an illumination structure of the present invention is comprised of a FPC (Flexible Printed Circuit) board, several light-emitting diodes and at least one pair of coupling device. The light-emitting diodes are coupled to the FPC board. The at least one pair of coupling device is mounted on respective opposite sides of the FPC board to allow the planar FPC board to be transformed into a three-dimensional shape.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is a decomposed view showing the first preferred embodiment of the present invention.

FIG. 3 is a schematic view showing the use of a second preferred embodiment of the present invention.

FIG. 4 is a schematic view showing the use of a third preferred embodiment of the present invention.

### DETAILED DESCRIPTION OF THE PREFERRED EMBODIMENT

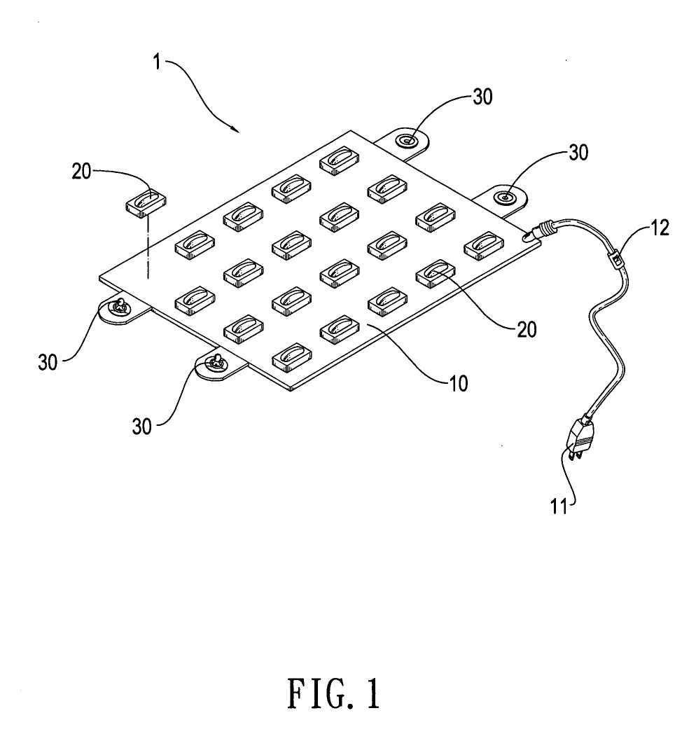

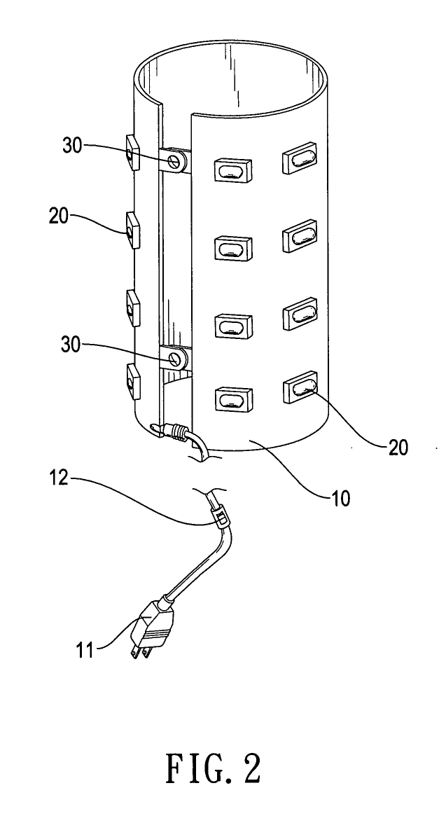

Referring to FIGS. 1 and 2, an illumination structure 1 of the present invention generally comprises a flexible printed circuit (FPC) board 10, several light-emitting diodes 20 and at least one pair of coupling device 30. In this preferred embodiment, the FPC board 10 is a square plate with a proper size. The FPC board 10 is processed to obtain a required wiring layout. In addition, a power cord is extended outwardly from the FPC board 10. A plug 11 is mounted on the rear end of the power cord. A switch 12 is mounted on the power cord.

The light-emitting diodes 20 are coupled to the FPC board 10.

There are two pairs of coupling devices 30 in this preferred embodiment, wherein each pair of coupling device comprises a female buckle and a male buckle mounted on respective opposite ends of the FPC board 10.

During its use, there is only a need to insert the plug 11 into a household power socket and switch on the switch 12 to cause the light-emitting diodes 20 to generate illumination. At this moment, the FPC board 10 is a plate that does not occupy space and it is easily attachable to the wall or the ceiling. Alternatively, the coupling devices 30 on respective opposite ends of the FPC board 10 can be coupled together to allow the FPC board 10 to form a cylinder for being held vertically. In addition, the switch 12 can be utilized to control these light-emitting diodes 20 for thereby achieving the illumination effect.

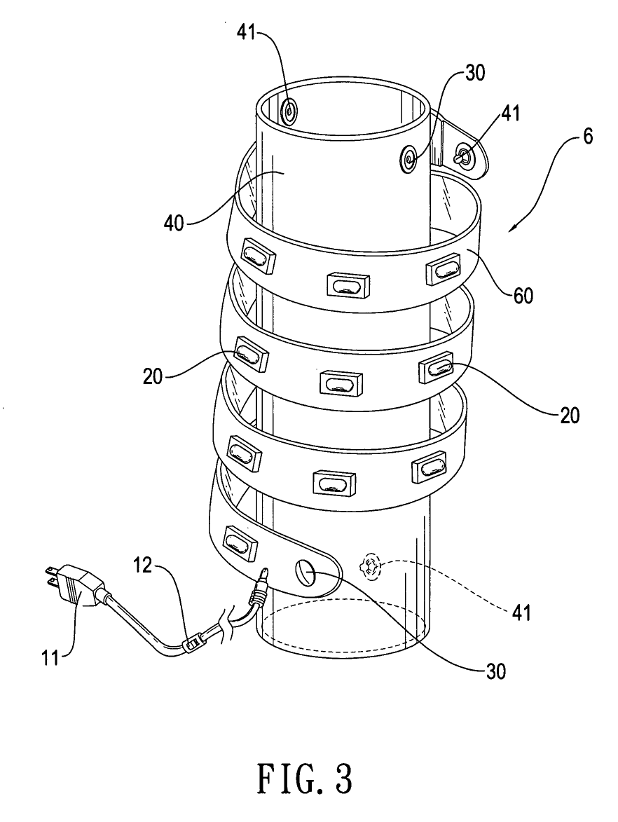

Referring to FIG. 3, an illumination structure 6 in accordance with a second preferred embodiment of the present invention is shown. The illumination structure 6 comprises a bar-shaped FPC board 60, several light-emitting diodes 20, at least one pair of coupling device 30 and a support frame 40. The FPC board 60 is processed to obtain a required wiring layout. The light-emitting diodes 20 are coupled to the FPC board 60. In addition, a power cord is extended outwardly from the border of the FPC board 60. A plug 11 is mounted on the rear end of the power cord. A switch 12 is mounted on the power cord. In this preferred embodiment, there is one pair of coupling device 30, which comprises a female buckle and a male buckle mounted on respective both ends of the FPC board 60. The support frame 40 is a hollow tube made of a transparent material. In addition, a coupling device 41 can be mounted on the upper and lower portions of the inside, the outside or the inside and outside of the hollow tube for coupling with the coupling device 30.

Accordingly, the coupling device 30 on one end of the illumination structure 6 can be coupled to the coupling device 41 on the outside of the support frame 40. Thereafter, the FPC board 60 can be arranged to wind around the outside of the support frame 40 directly. In addition, the coupling device 30 on the other end of the illumination structure 6 can be coupled to the coupling device 41 on the outside of the support frame 40 so that the FPC board 60 and the support frame 40 can be coupled together. Furthermore, the FPC board 60 can be disposed on the inside of the support frame 40, and the coupling devices 30 on both ends of the FPC board 60 can be coupled to the coupling devices 41 on the inside of the support frame 40 so as to couple the FPC board 60 to the inside of the support frame 40. Thereafter, the plug 11 can be inserted into the power socket so as to achieve the illumination and decoration effects.

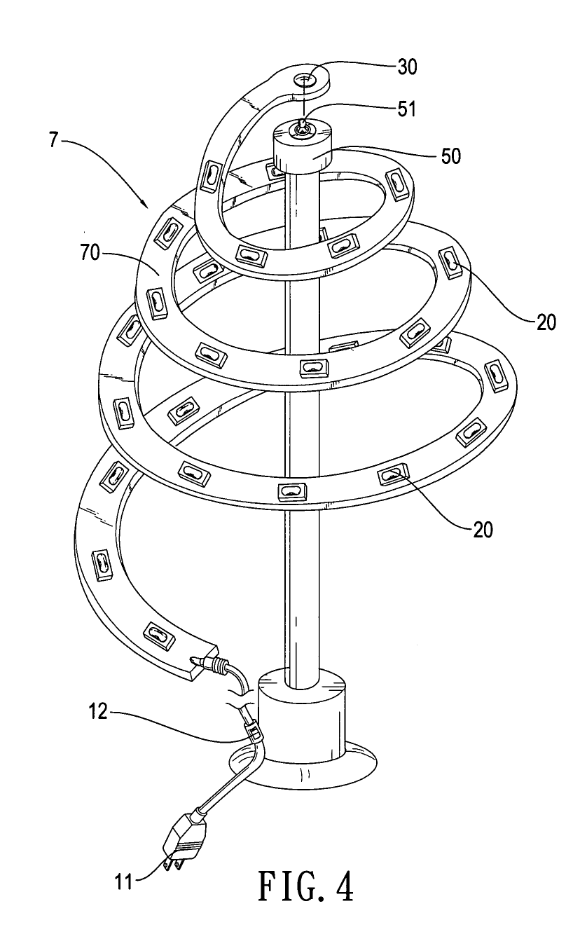

Referring further to FIG. 4, an illumination structure 7 in accordance with a third preferred embodiment of the present invention is shown. The FPC board 70 has a spiral shape. The FPC board 70 is processed to obtain a required wiring layout. The light-emitting diodes 20 are coupled to the FPC board 70. A coupling device 30 is mounted on one end of the central portion of the FPC board 70. A power cord is extended outwardly from the other end of the FPC board 70. A switch 12 is mounted on the power cord. A plug 11 is mounted on the rear end of the power cord. In addition, a support rod 50 that has a bottom bracket is provided, wherein a coupling device 51 is mounted on the top portion of the support rod 51 for coupling with the coupling device 30 of the FPC board 70. During its use, there is only a need to couple the coupling device 30 on the central portion of the FPC board 70 to the support rod 51 on the top portion of the support rod 50 to locate the central portion of the FPC board 70 at a higher position with the surrounding peripheral portion drooping. Thereafter, the plug 11 can be inserted into the household power socket and the switch 12 can be also switched on to cause the light-emitting diodes 20 to generate light for achieving the illumination and decoration effects.

Furthermore, the support frame 40 and the support rod 50 may not be applied to the bar-shaped FPC board 60 (shown in FIG. 3) and the spiral-shaped FPC board 70 (shown in FIG. 4). For example, the FPC board 60 may optionally be arranged to wind around the outside of other object directly. Thereafter, the coupling devices 30 on respective both ends of the FPC board 60 (or the FPC board 10 shown in FIG. 1) can be coupled to each other, thereby completing the assembly. In addition, the central portion of the FPC board 70 can be hung directly to achieve the same purpose.

In accordance with the foregoing description, the present invention has the following practical advantages:

1. The illumination structure is composed of simplified components, and the FPC board, which is flexible and bendable to any angle, can be used together with the coupling device so as to achieve the space-saving effect.

2. The FPC board can be supported by itself or other support means so as to transform the planar FPC board into a three-dimensional shape, thereby providing illumination and decoration effects.

To sum up, the illumination structure of the present invention is capable of achieving the anticipated objects described above. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An illumination structure, comprising:
a FPC (Flexible Printed Circuit) board having a circuit formed thereon and a power plug extending therefrom;
a plurality of light-emitting diodes coupled to said FPC board; and
at least one pair of coupling device mounted on a respective end of said FPC board to allow said FPC board to be transformed from a planar shape into a three-dimensional shape.

2. An illumination structure according to claim 1, wherein a switch is mounted on said power plug of said FPC board.

3. An illumination structure according to claim 1, wherein said FPC board is a square plate, and said at least one pair of coupling device is mounted on respective opposite sides of said square plate.

4. An illumination structure according to claim 1, wherein said FPC board is a bar-shaped board, and said at least one pair of coupling device is mounted on respective opposite sides of said bar-shaped board.

5. An illumination structure according to claim 4, wherein said bar-shaped FPC board further works together with a support frame, which is a hollow tube made of a transparent material, and a male coupling device and a female coupling device are mounted on respective upper and lower portions of the outside of said hollow tube.

6. An illumination structure according to claim 4, wherein said bar-shaped FPC board further works together with a support frame, which is a hollow tube made of a transparent material, and a male coupling device and a female coupling device are mounted on respective upper and lower portions of the inside of said hollow tube.

7. An illumination structure according to claim 4, wherein said bar-shaped FPC board further works together with a support frame, which is a hollow tube made of a transparent material, and a male coupling device and a female coupling device are mounted on upper and lower portions of the outside and the inside of said hollow tube.

8. An illumination structure according to claim 1, wherein said FPC board has a spiral shape, and said FPC board further works together with a support rod, wherein said at least one pair of coupling device is mounted respectively on a central portion of said spiral-shaped FPC board and a top portion of said support rod.
